(19) United States
(12) Patent Application Publication
(10) Pub. No.: US 2011/0096332 A1
(43) Pub. Date: Apr. 28, 2011

(54) METHOD AND DEVICE FOR GAS ANALYSIS USING AN INTERFEROMETRIC LASER

(76) Inventor: Renato Bugge, Trondheim (NO)

(21) Appl. No.: 12/736,390

(22) PCT Filed: Mar. 4, 2008
(86) PCT No.: PCT/NO2008/000123

§ 371 Date: Dec. 16, 2010

(51) Int. Cl. G01B 9/02

(52) U.S. Cl. 356/477

(57) ABSTRACT

The invention relates to design of an interferometric laser and a method for analyzing gas with this, preferably methane, ethane, propane, butane, pentane, hexane, heptane, ethylene, dichloromethane, isooctane, benzene, xylenes, hydrazine, formaldehyde, N₂O, NO₂, CO₂, CO, HF, O₃, HI, NH₃, SO, HBr, H₂S, HCN, preferably a tunable interferometric laser which can sweep a spectrum.

### THE FIELD OF THE INVENTION

The invention relates to the design of an interferometric laser and a method for analyzing gas with this, preferably methane, ethane, propane, butane, pentane, hexane, heptane, ethylene, dichloromethane, isooctane, benzene, xylenes, hydrazine, formaldehyde, N₂O, NO₂, CO₂, CO, HF, O₃, HI, NH₃, SO, HBr, H₂S, HCN, preferably a tunable interferometric laser which can sweep (scan) a spectrum, according to the preamble of claim 1.

The laser includes a new type optical ridge waveguide with sloping sides, and is formed by wet etching of the upper cladding. This new type ridge waveguide provides a single mode light guiding with a broader ridge width than conventional ridge guides.

A ψ-junction semiconductor laser consists of one or more ψ-junctions that are etched into the upper cladding of the device. The ψ-junction is a new junction design that makes it possible to make optical junctions made by wet etching. The ψ-junction(s) are connected to two or more optical ridge waveguides in the device. The optical waveguides are embedded in an optical cavity, in which light is reflected back and forth to achieve lasing.

The end surfaces of the optical waveguides and/or junctions can be coated to reduce or increase the reflection.

With two or more optical waveguides, the device can be tuned to different wavelengths by individually changing the injection current into the different optical waveguides. The region which the wavelength can be tuned within is dependent on the layer thickness, material composition and strain in the layers.

An optical junction modulator consists of two optical waveguides that are connected at two junctions with the new ψ-junction design. Before splitting and after coupling of the light in the junction, a single waveguide will start and end the device. The waveguide or junction ends can be coated to achieve lower or higher reflection, in or out of the device.

Other devices can be optical waveguide(s), an optical coupler/decoupler, and an Arrayed Waveguide Grating or similar. These devices can be passive or active devices, with or without an active region. For both active and passive devices, metal contacts can be used to heat parts of or entire devices to trim parameters as refraction index, mechanical stress and alike, that affects the optical performance of the device. For active devices, the device will have optical gain in parts of or the entire device by electrical injection into the area and/or layers.

### BACKGROUND

Measuring of gas with light is performed by using wavelengths having absorption of a given gas. This is presently usually done with an Infrared lamp (ref) or DFB/DBR lasers (ref), where the first technique is based on filtering of the light to achieve the desired wavelength, while the second is based on a laser with a grating to achieve the desired wavelength. These are methods which have been used in different products (ref) and which preferably are suitable for cheaper and more expensive gas measurement systems, respectively. An Infrared lamp has large power consumption, while a DFB/DBR laser needs more accuracy and more expensive temperature control to work. Temperature control also increases the power consumption, as one usually uses thermoelectric cooling to set the temperature.

In an attempt to combine the low costs of IR lamps with the accuracy of a laser based measurement, and at the same time have a power consumption which will make it possible to have a handheld/portable device, it is in this invention presented a novel method for measuring gas with an interferometric laser.

To be able to make integrated optical devices, as semiconductor micro-lasers, one must guide the light through the device. This can be done by making optical waveguides in the device, such as ridge waveguides or similar. For a junction laser can such a ridge guide be straight, curved and/or with junctions. For a junction laser, such as a Y-junction, the performance of the device is dependent on which resolution that can be achieved by etching of the junction. Better resolution means a more V-like shape for the inner part and has a better effect transmission, as the junction looks more like a real Y (P. Sewell et al. (1997)). This has traditionally been performed by the use of dry etching, as reactive ion etching (RIE) (K. Al Hemyari et al. (1993)). The RIE process can result in an isotropic etch, where the etching surface is positioned normal to the surface plane, and side walls and ridge design are positioned perpendicularly.

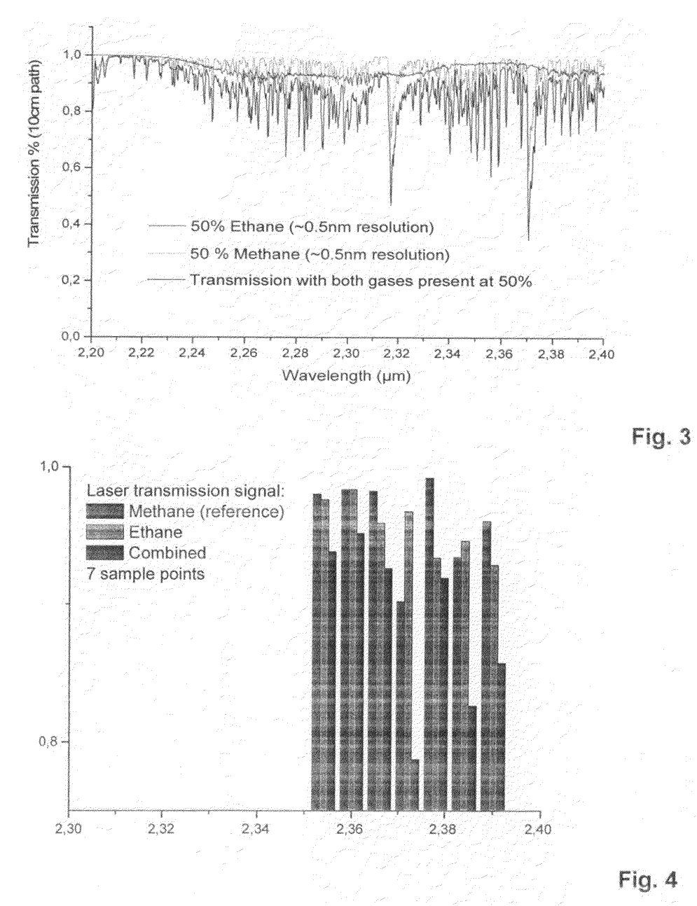

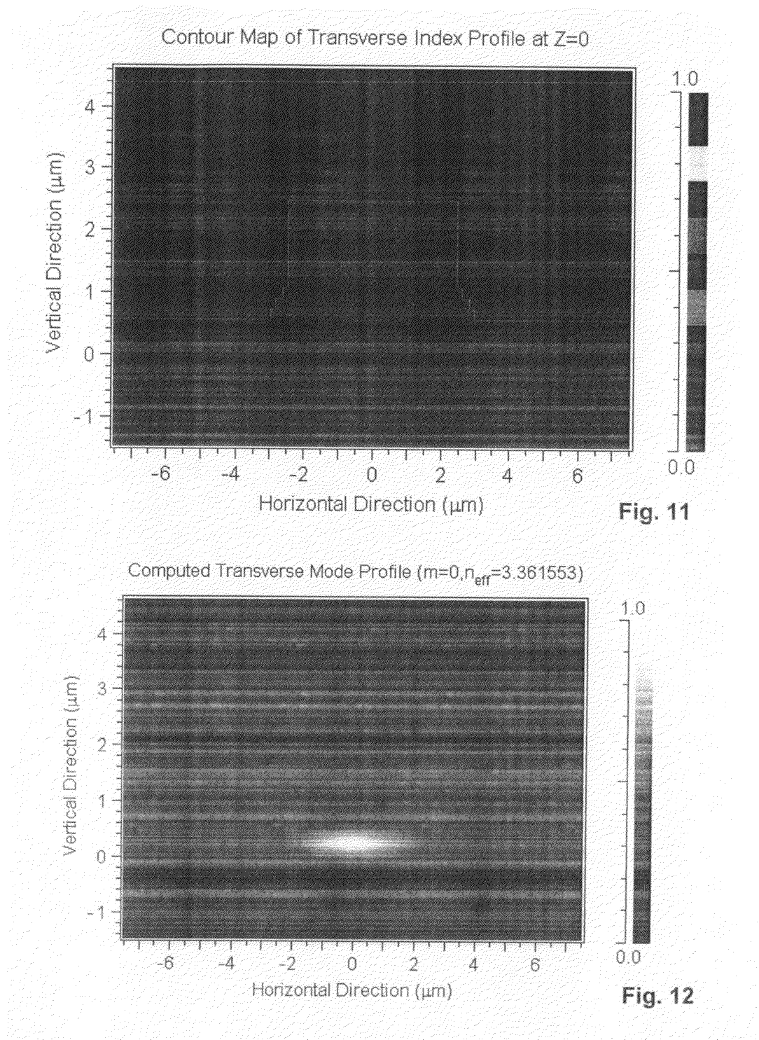

A general method for making materials on a substrate with the composition AlₐGa_{b}In_{c}P_{d}AsₑSb_{f} (which effectively refers to all the III-V materials), has been theoretically referred to in prior art (GB 1,097,551 (1965)). The present invention has a design where the device must have at least four layers of different compositions. In addition, the present device needs doped layers, an outlay with insulation, contacts and must be etched to shape electro-optical structures. Other prior art (JP 100 12918A, U.S. Pat. No. 6,236,772 B, Werner et al. (2000), EP 0 651 268 A1) describe other aspects of known techniques for electro-optical and optical devices. In U.S. Pat. No. 6,236,772 B one has demonstrated a device containing a traditional optical splitter/coupler with a Y-junction. The present invention is different from this in that it does not include a V-shaped detail in the junction point (FIG. 7a), but has a U-shaped detail in the new junction as a result of the wet etching process (FIG. 3b). The device presented in U.S. Pat. No. 6,236,772 B cannot be made by wet etch, since such a U-shape in a traditional Y-junction will result in loss of light. EP 0 651 268 A1 describes another optical junction device with in and out waveguides. By comparison with the present device, one can see that these waveguides are made of two different materials (in both the directions perpendicular to the light direction). This distinguishes that invention from the present invention, where the present invention is a ridge waveguide which only has one effective refraction index difference and no difference in the material at the substrate plane (i.e. the horizontal direction in FIG. 11). JP 100 12918A describes a light emitting device of GaAlAs and GaAs with n-type and p-type doped material layers. The device includes no optical waveguides and is a spontaneous light emitting device (in contrast to the stimulated emission in the present device) for wavelengths less than 1 μm (due to band gap limitation for AlGaAs and GaAs).

A wet etching process has earlier been developed (patent NO 20026261) which can etch AlGaInAsSb materials with good control and anisotropic shapes. This etch solution was used to provide patterns and new structures in the present invention.

### OBJECT

The object of the invention is to provide a method for and the design of a laser for analyzing gas by means of an interferometric laser. It is also an object that this method should be reliable, and that it could be used for different types of lasers.

It is also an object of the invention to provide a laser for gas analysis which is less expensive than prior art solutions.

### THE INVENTION

The method according to the invention is described in claim 1. Preferable features of the method are described in claims 2-21.

A device for gas analysis is described in claim 22. Preferable features of the device are described in claims 23-47.

The invention will in the following be described in further detail with reference to the attached drawings, where:

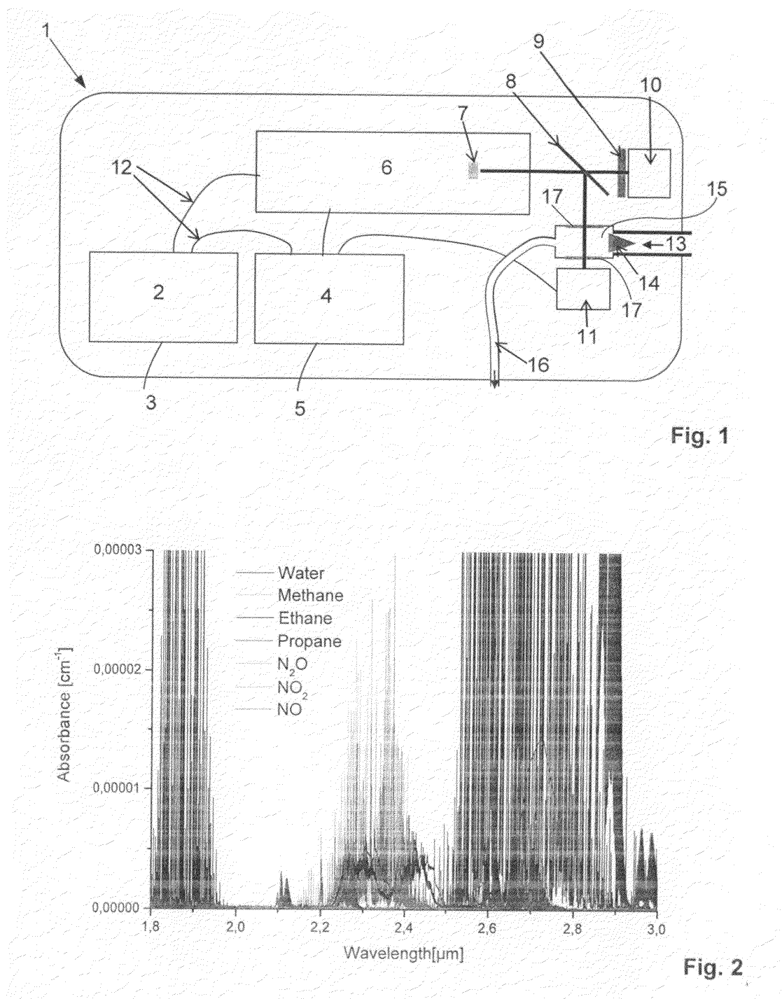

FIG. 1 shows schematically an arrangement for a laser module for executing the method according to the invention,

FIG. 2 shows absorbance curves for different gases which show overlapping areas and wavelengths for sensing,

FIG. 3 show transmission curves for ethane and methane at 50% concentration (1000 mbar total) and for both gases at 22.85° C., and an optical path length of 10 cm,

FIG. 4 is an example of transmission sampling of ethane and methane,

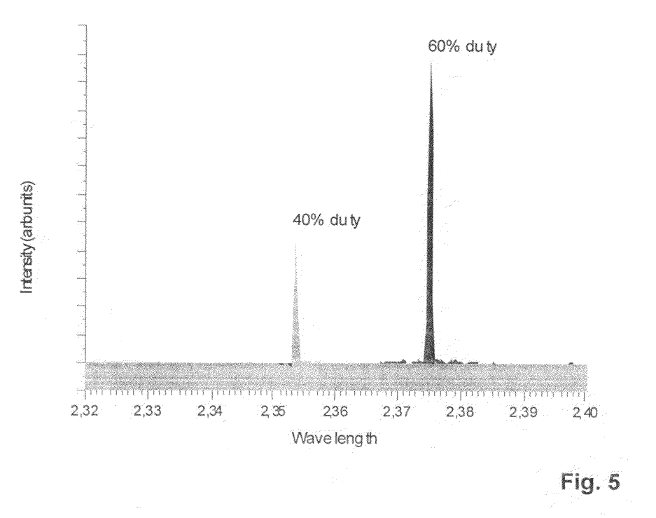

FIG. 5 shows laser output from two duty cycles,

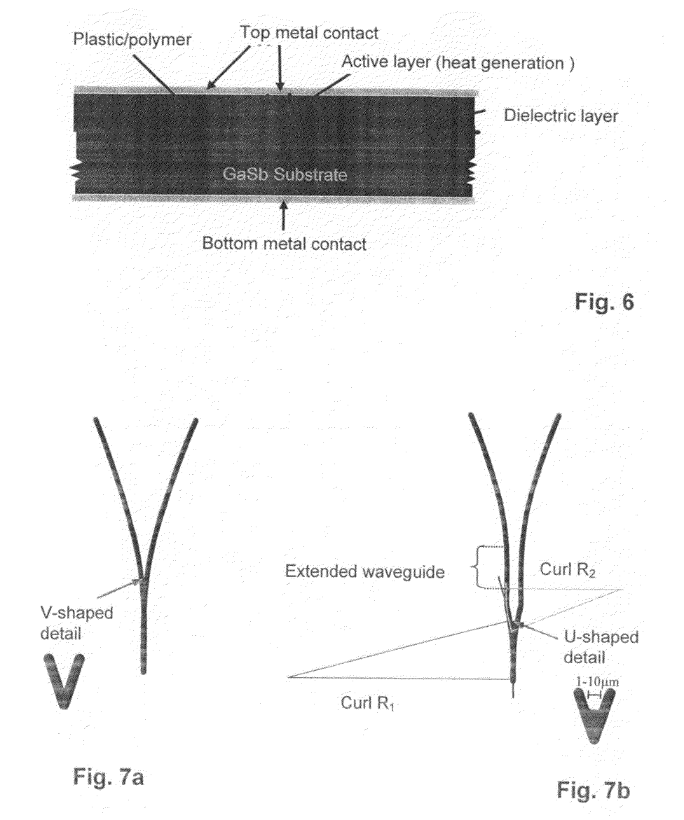

FIG. 6 shows schematically the structure of a laser according to the invention,

FIG. 7a shows a schematic outlay of a traditional Y-junction design,

FIG. 7b shows a schematic outlay of a novel ψ-junction design,

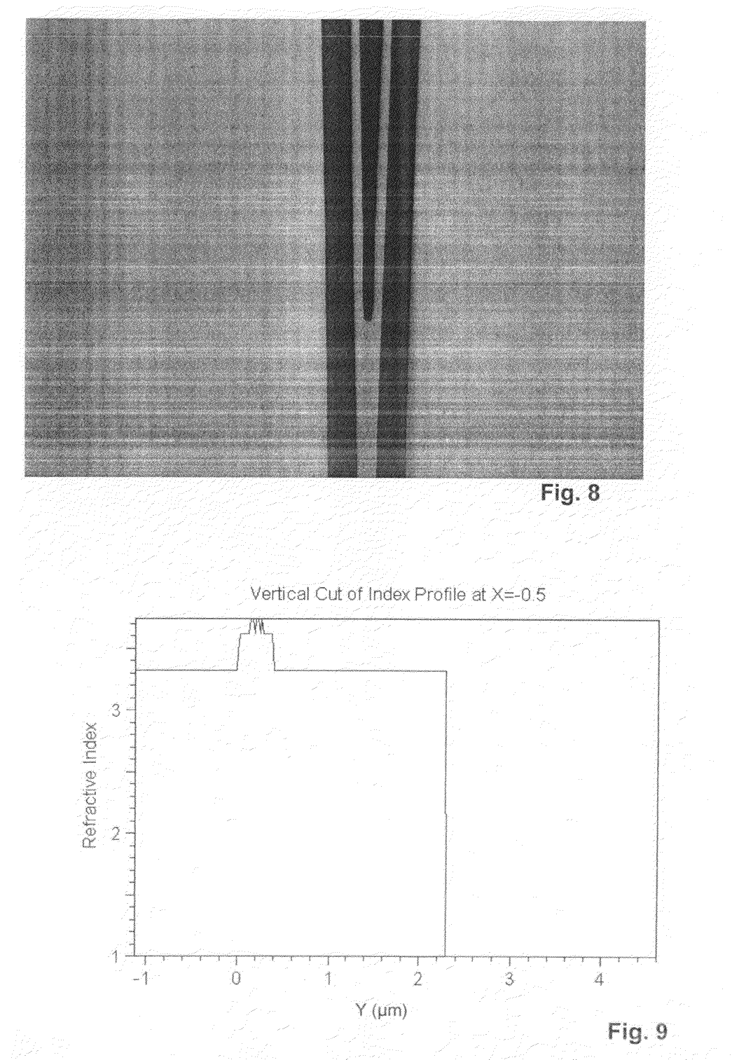

FIG. 8 shows a microscopic picture of a ψ-junction ridge (500×),

FIG. 9 shows a refractive index profile,

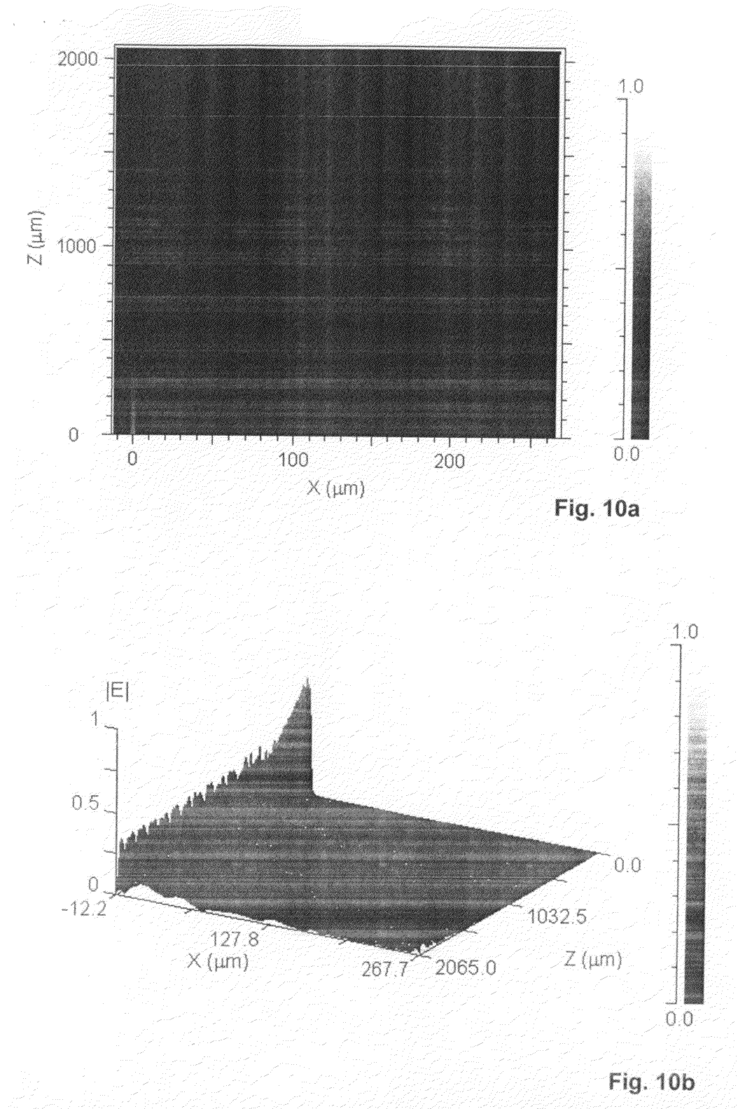

FIGS. 10a and 10b show plots of optical field,

FIG. 11 shows refractive index cross-section,

FIG. 12 shows fundamental mode,

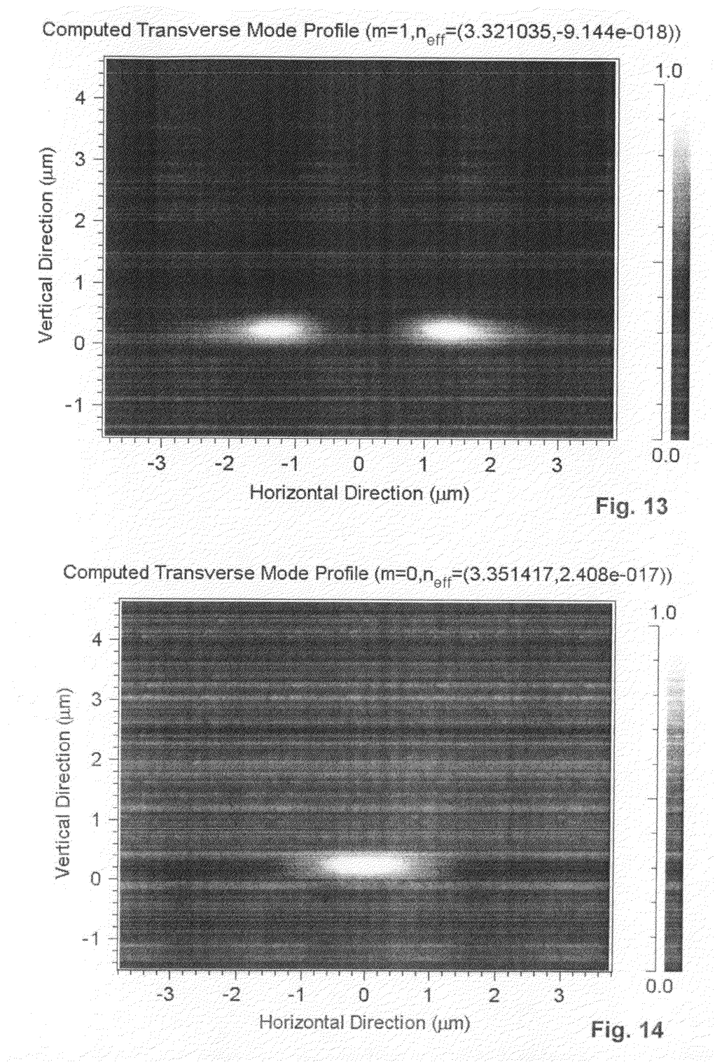

FIG. 13 shows transverse mode m=1,

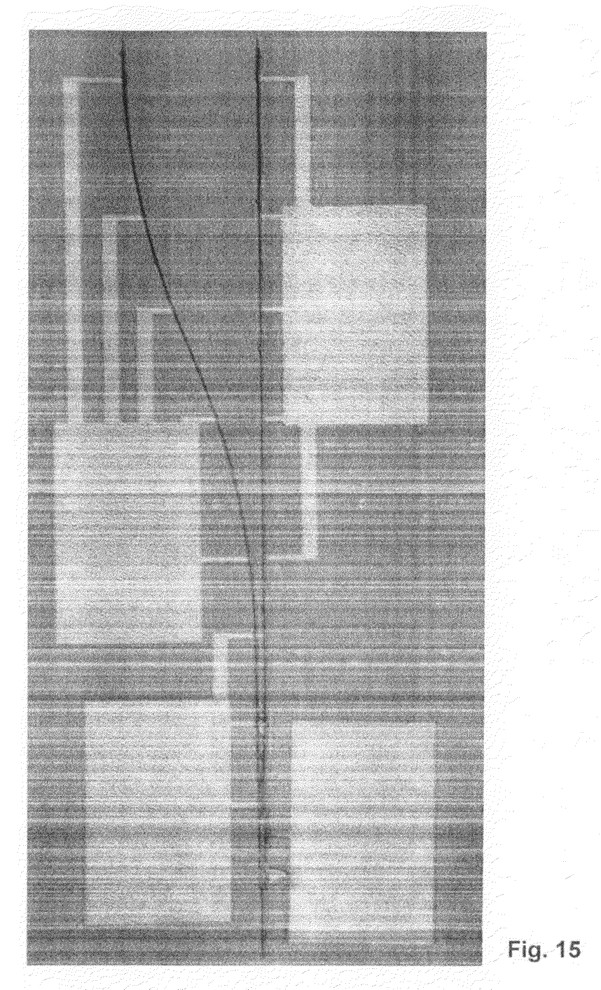

FIG. 14 shows transverse mode m=0,

FIG. 15 shows a microscopic picture of a laser,

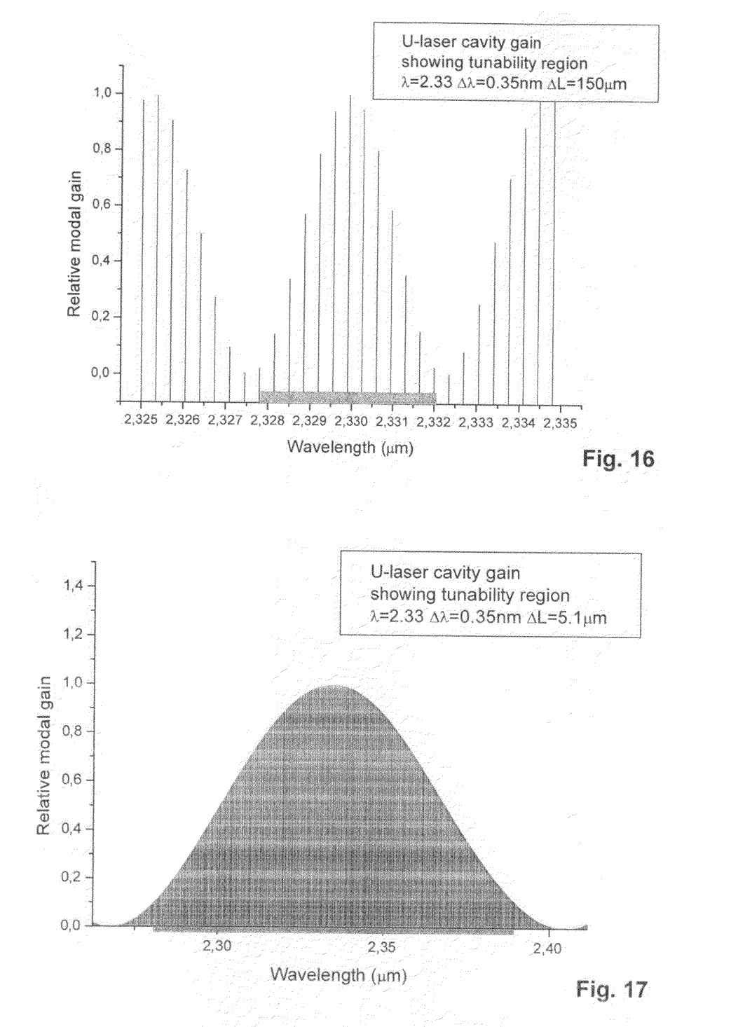

FIG. 16 shows modal gain,

FIG. 17 shows modal gain,

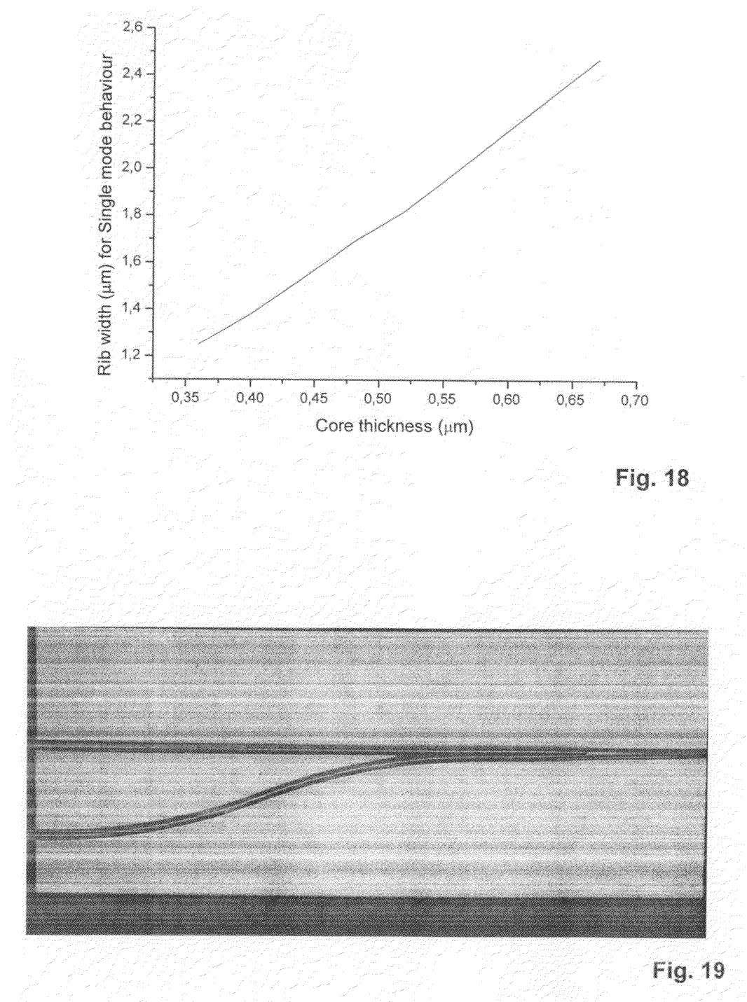

FIG. 18 shows maximal waveguide ridge width,

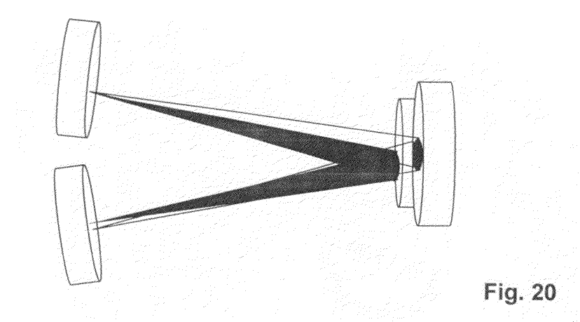

FIG. 19 shows a picture of a ψ-junction ridge, and

FIG. 20 shows that with several curved mirrors, the light is reflected in a larger volume and will have a displacement through each “round” which makes it possible to achieve a certain number of reflections/path length, before the light is taken out by an aperture. Here are shown 4 mirrors and one “round” between these. The light enters and leaves the beam path through a hole in one of the mirrors.

To be able to make junction lasers and other optical junction devices by wet etching, the design of the device must be changed from the traditional junction design. In wet etching, the V-detail in a Y-junction will end up as a U-like detail after the processing due to the anisotropic of the etch (FIG. 8). For a Y-junction laser designed device, this will result in a non-working device, but by use of the design rules of the present invention one can also make a working junction device.

To make a ridge on a wafer, one must use a masking material on the wafer surface. After processing/applying, the masking material will define the outlay of the ridge structure. By further processing of the wafer, a chemical wet etching will etch the material which is not masked by the masking material. Due to the anisotropy of the wet etching (used here), the etch may result in some etch under the edge of the masking material (under etch). The under etch had to be considered as we designed the ridge structure, as it provides a U-like detail at the inner part of the junction, as shown in FIG. 7. Such a U-detail will result in loss of light in a traditional Y-junction ridge structure.

The idea of the present invention was to incorporate curves in the opposite direction of the junction curve, to extend the waveguides in the junction region and to collect light being lost in the U-detail in the ψ-junction (FIG. 7). The U-shaped detail is a result of the isotropic wet etch, so that it was important to reduce the consequence of this detail to be able to make usable wet etch junctions.

During the design phase, the optical waveguide properties of the ψ-junction-based device had to be simulated to test the junction before it was made. By use of the waveguide propagation method (BMP) we simulated the waveguide junctions. FIG. 10 shows the propagated optical field in one of our ψ-junction outlays. Some loss at the splitting of the light can be seen, but most of the field is contained in the waveguides.

Optical connection of the devices in the present invention is provided by connecting the waveguides to other waveguide devices through optical fibers, incorporating waveguides, planar waveguides, ridge waveguides, reader and similar. By using coating with higher or lower reflection, or a design which adjusts the optical field at the end of the waveguides of the device, one can reduce the connection loss.

The laser and the manufacturing of the structure of a ψ-junction laser is made by etching down in a material with the composition AlₐGa_{b}In_{c}P_{d}AsₑSb_{f} (which effectively refers to all the III-V materials), where an inexpensive wet etch method is used to make an interferometric laser structure. To be able to measure a gas at the highest possible degree of accuracy, one must have a single mode laser with one frequency, i.e. a laser which does not emit several wavelengths. This consists in choosing the length of two waveguides in such a way that the suppression of side modes is sufficiently high, so that these do not emit light. To improve the emission from the ψ-junction laser we have chosen to change the manufacturing to include a soft plastic layer between the dielectric layer and the metal top layer, and have over 200 nm Gold as the top contact at the plastic layer, as shown in FIG. 6. The meaning of the plastic layer is to let the active layer of the laser and the contact metal “float” over each other, and reduce tension from thermal expansion, when the laser is soldered to a holder. By doing this one can solder the top contact (the one closest the ridge structure) down against the holder without introducing cracks and destroying the laser. This is especially important in connection with a junction laser, where one have two arms which are separated in a junction, as shown in FIG. 7. It is also important that this junction has a U-shaped detail from a method as described above. A V-shaped detail (FIG. 7a) will increase the tension as the soldered contacts, which are positioned at the arms, expand or contract as a consequence of the soldering process, where one can have temperatures up to 370° C. The combination of a U-shaped detail and an intermediate layer of plastics/polymer will reduce the tension to a degree that enables production of lasers with the top side down against the holder. This is important since a lot of heat is generated in the laser and it is more effective to guide the heat out from the top contact than through the 50-500 μm thick substrate and out through the bottom contact. Accordingly, the invention is based on mounting the laser with the top contact down against a holder.

To perform the method of measuring gas, an interferometric laser is preferably used, preferably a tunable laser which can scan a spectrum. The laser is preferably arranged in a device for detecting gas, which device preferably includes power supply connected to an auxiliary current or a battery, a control unit connected to an external communication, a laser module with an interferometric laser (on a holder), a beam splitter, reference cell, a reference detector and electrical wires.

In addition the device includes a channel/perforated holes for the introduction of gas for analysis, which channel preferably has a one-way valve at the end before the channel runs out in a sense chamber, and next out into an outlet channel for gas.

The method for analyzing gases, preferably methane, ethane, propane, butane, pentane, hexane, heptane, ethylene, dichloromethane, isooctane, benzene, xylenes, hydrazine, formaldehyde, N₂O, NO₂, CO₂, CO, HF, O₃, HI, NH₃, SO, HBr, H₂S, HCN, is based, as mentioned, on the use of an interferometric laser which preferably has an interferometric mode “step” of about 5-6 nm. The easiest way to tune a laser through digital controlling, in this case, will be to change the duty cycle for a pulse, but keeping the current constant. In this way, several single mode lines can be achieved for the collection of data within a wavelength region. FIG. 4 shows how a collected spectrum consisting of 50% methane and 50% ethane will look like.

The light emitted from the laser and which runs through the light splitter will next be divided and run through the sense chamber and a reference, respectively. The light will be dampened of the gases in the sense chamber before it hits a measuring detector. The light runs through the reference, e.g. methane gas in a cell can be used to calibrate the measurement, explained in further detail below.

The signal will be analyzed in the device for gas analysis by means of an internal microcontroller arranged in the control device, which next will be able to reveal the gas concentrations. To do this, the reference detector is used to determine the actual wavelength position of the laser light as it is swept. The reference detector consists of a detector with a cell of a known gas in front (possibly with an etalon cell or similar instead of gas if it is preferable). FIG. 3 shows how, for example, the transmission spectrum for methane and ethane looks like for a 0.5 nm resolution scan (for a set of several possible wavelength positions). To take into consideration effect changes over long time in the laser, a third detector can be integrated to maintain the energy reading for the laser normalized, alternatively by using the reference detector for this in combination with a thermistor for reading the temperature.

How the laser reacts to changes in duty cycles will now be described.

The laser changes wavelengths of the light it emits with consideration to duty cycles, as shown in FIG. 5 (for 40% and 60% operation at 10 kHz). Within these states, the laser will have an emission from other interferometric modes/wavelengths. These emitted wavelengths have usually an interval of 5-6 nm (5.25 nm in FIG. 5) and only one or two of them will dominate.

To reduce costs and system energy consumption, an advance calibration can be made and the laser temperature control be omitted.

This means that for a given duty cycle, either one or two wavelengths will be emitted. Changes over long time in the laser will also affect which wavelengths being emitted, so that there is a need for a method for calibration of this to obtain accurate measurements.

From FIG. 5 we can expect three points for wavelength emission between 40% and 60% duty cycles, therefore will 45%, 50% and 55% be possible. Between there (i.e. 41%, 42%, etc.) the laser will submit two frequencies in a gradual transition from an interferometric mode to another. There is therefore a need for a method that establishes when a single wavelength is emitted.

How to compute and calibrate the laser wavelength will now be described.

As can be seen in FIG. 4, there are methane absorption for three different interferometric modes/wavelengths next to each other. Thus, the methane reference detector can be used to establish whether there is a single frequency emission from the laser.

There are five possible states:

1. The middle wavelength absorption is higher than the two others,

2. The middle wavelength absorption is lower than the two others,

3. The middle wavelength absorption is between the two other frequencies,

4. Two of the wavelength absorptions are equal,

5. Three of the wavelength absorptions are equal.

In cases 1 and 2 there will be a maximum and minimum in the transmission spectrum, which will be the point where a single wavelength is produced.

Another way to describe this is mathematically. As a laser produces two wavelengths, the transmission signal will be a result of the absorption from each of these wavelengths. Thus, if wavelengths 1 and 2 have absorbance A₁ and A₂, the total transmitted intensity will be:

I=I_{0,1}*exp(−A₁*L*ε)+I_{0,2}*exp(−A₂*L*ε)

L will be constant and E will be proportional with the molar concentration of the gas, so for simplification we can write:

I−I_{0,1}*exp(−A₁)+I_{0,2}*exp(−A₂)

If for example 40% and 45% produces a single wavelength, the values (41%, 42%, etc.) will be a weighted sum of the two wavelengths which depends of the duty cycle:

X=[40% . . . 45%]

I=I*(20*(45%-X))*exp(−A₁)+I*(20*(X−40%))*exp(−A₂)

Even without knowing the actual wavelength, X can be extracted by using the methane reference and a spectral library to find A₁ and A₂. The program must know the modal interval for the laser (this can be pre-calibrated), so that it can compute the simulated transmission spectrum for different wavelength positions and compare it with the measured spectrum to acquire the absolute value for the single wavelength points.

How the gas concentrations are computed will now be described.

After the wavelength is calibrated by the methane reference signal, the transmission signal from the measuring detector is used to find the individual gas concentrations. In the case used for this description there were three gases, the absorption from each gas is collected from a library and then related to the measured transmission. The transmission for each wavelength is then related to the measured transmission. The transmission for each wavelength is so dependent of the absorption for each gas at a wavelength according to:

T=I₀/I=1/(exp(−aₘₑₜₕₐₙₑ)+exp(−aₑₜₕₐₙₑ)+exp(−aₚᵣₒₚₐₙₑ))

Where aₘₑₜₕₐₙₑ, aₑₜₕₐₙₑ and −aₚᵣₒₚₐₙₑ is the absorption of methane, ethane and propane, respectively. For each wavelength, a is related to an absorption by:

a=A*L*ε

Where L is constant and E is the concentration which is desired to find. Thus, by having three single wavelength lines one gets three equations and three unknowns, which easily can be solved. For more lines, a weighted method can be used to increase the accuracy of the measurement.

Further details of the invention will appear from the following example description.

To make tunable lasers, a new laser type, named ψ-junction laser, was designed so that wet etching could be used for the junction structure of the device. FIG. 8 shows such a ψ-junction after wet etching, where one can see the typical U-detail in the inner part of the junction. FIG. 7 shows the difference between a traditional junction design and the new type of junction. FIGS. 9 and 11 show a vertical profile and a contour map of the refractive index through the simulated structure. The graded contour of the profile in FIG. 11 is due to wet etching, which results in a graded ridge structure from under etch of the photoresist. FIGS. 12 and 13 show that the ridge structure in FIG. 11 (5 μm wide at the top) has more than one mode. This is preferential as regards a single mode control (of the light), as the simulated ridge structure was a single mode for widths of 3.2 μm to 3.4 μm.

This is accordingly much broader than what the effective index method gives for a quadratic ridge structure (without graded sides). FIG. 18 shows that a traditional ridge with RI=3.30 in cladding and 3.62 in the core (0.4 μm thick), must be 1.38 μm wide or thinner to be a single mode. It is thus an improvement to utilize a graded edge at the cladding, as it advises broader single mode ridge structures, and thus higher injection current than for the quadratic ridge structure.

FIG. 10 (a and b) shows the optical field from the simulation of beam propagation in the ψ-junction which is used here. In FIG. 10, the optical field enters at Z=X=0 and is propagated to Z=2000 μm where the most of the optical field is divided between two waveguides. This shows that the ψ-junction can be used as an optical splitter in the laser.

The new ψ-junction was incorporated in the laser structure to achieve two optical paths with different lengths. This enables suppression of the longitudinal mode, so that a longitudinal single mode operation of the device can be achieved. By applying ohmic Ti/Pt/Au metal contacts to the GaSb contact layer, which lies at the top of the ridge structure, one can achieve electro-injection. For aperture injection, a Pd/Pt/Au metal contact was connected with the n-type GaSb substrate. Optical emission was so achieved by electrical injection in the active layer under the ridge structure. In other words, optical amplifying was achieved in the waveguides so that a stimulated emission could be achieved. By splitting the end surfaces of the device, one achieved reflections (of the light) at the end of the two optical cavities. The metal contacts where connected to metal surfaces by metal connections at the top of an electrical insulating layer of spin-on glass. Four different contact surfaces for connecting the device to a power supply, where connected to different parts of the ridge structure of the device, as shown in FIG. 15. This made it possible to tune the device to different wavelengths by changing the injection current in the different parts. The difference in length between the two wavelength arms in the laser determines the tunability of the laser. For a length difference in the arm of ˜150 μm (as in the device of FIG. 15), the wavelength can be tuned up to ˜4 μm without “jumps” in wavelength/mode (see FIG. 16), while a length difference of only ˜5 μm results in over 100 μm between the interferometric modes, as shown in FIG. 17. In both devices the wavelength is changed by changing the injection current of the laser and/or by changing the temperature of the device.

FIG. 1 shows schematically a laser module for executing the method according to the invention. A laser module 1 includes power supply 2, connected to auxiliary power or a battery 3, a control unit 4 connected to external communication 5, a laser module 6 with a semiconductor laser 7, a beam splitter 8, a reference gas cell 9, a reference detector 10, a detector 11 and electrical wirings 12. The reference gas cell 9 can be exchanged with a reference material or an etalon (for reference). For cheaper detection one can assume that the reference calibration is preformed in advance and thus remove 9 and 10, and exchange 8 with a mirror.

In addition the device 1 includes a channel 13 for introducing gas for analysis, which channel 13 preferably has a one-way valve 14 at the end, before the channel runs out into a sense chamber 15, which chamber 15 tapers into an outlet channel 16 for gas. In the case where one measures the surrounding atmosphere, the valve 14 can either be removed or exchanged with a pump for effective supply to the chamber 15, possibly the chamber 15 can be perforated and moved out of 1.

The electrical wiring 12 is preferably both for energy supply to the laser and energy supply to the electronics.

External communication can be a system panel, data logging or a PC for storing or further analysis of data.

In use this will work in that:

The laser module 6, which includes the interferometric laser, sends a light beam to a beam splitter 8 which divides the light signal in two. The one part of the light signal runs via a reference gas cell 9 and is measured by a reference detector 10. The other part of the signal runs into the sense chamber 15 via transparent apertures 17 arranged in the wall, where the signal is dampened by the gases in the chamber 15, and then measured by the detector 11.

The measurements from the reference detector 10 and detector 11, respectively, are the results which are used further in the method, as explained above. The results from the measurements are transferred to the control unit 4, where they are stored in an internal memory and/or transferred to external communication means for further analysis.

### Modifications

Alternative embodiments of the invention may be:
i) Including two semi-transparent mirrors in the gas cell (17 in FIG. 1) to let the light be reflected back and forth between these, and in this way increase the path length for the light in the gas (especially important at low gas concentrations or low absorption coefficients).
ii) Providing the mirrors described in i) (17 in FIG. 1) with a small angle to avoid creating standing waves, i.e. that the beam will move along the gas cell for each reflection so that 11 in FIG. 1 must be moved correspondingly.
iii) Using a mirror with high reflection in the arrangement under ii), but having an optical aperture for letting the laser in at one place and out another place.
iv) Using curved mirrors to reflect the laser back and forth between these and have an optical aperture to let the light in at one plate and out from another.
v) Using 3-4 curved mirrors to reflect the laser back and forth within a larger volume in a gas cell, as shown in FIG. 20.
vi) The accuracy of the gas measurement may be increased by utilizing a filter to remove the lasers at the output of the gas cell, and thus measuring the gas by Photoluminescence Excitation Spectroscopy or Resonance Raman Spectroscopy, which increases the accuracy of the measuring with a junction laser.

### REFERENCES

1. Patent NO 20026261: “A new etch”
2. Choi H. K. og Eglash S.:“High-efficiency high power GaInAsSb—AlGaAsSb Double-Heterostructure Lasers Emitting at 2.3microns”, pp.1555-9, IEEE Journal of Quantum Electronics, Vol.27, No.6 (1991)
3. Simanowski S., Mermelstein C., Walthers M., Herres N., Kiefer R., Rattunde M., Schmitz J., Wagner J. og Weimann G.: “Growth and layer structure of 2.26 μm (AlGaIn)(AsSb) diode lasers for room temperature operation”, pp.595-9, Journal of Crystal Growth, Vol.227-228 (2001)
4. Yarekham D. A., Vicet A., Perona A., Glastre G., Fraisse B., Rouillard Y., Skouri E. M., Boissier G., Grech P., Joullie A., Alibert C. og Baranov A. N.: “High efficiency GaInSbAs/GaSb type-II quantum well continuous wave lasers”, pp. 390-4, Semiconductor Science and Technology, Vol. 15 (2000)
5. Sewell P., Benson T. M., Anada T., Kendall P. C.: “Bi-oblique propagation analysis of symmetric and asymmetric Y-junctions”, pp.688-96, Journal of Lightwave Technology, Vol. 15, Iss. 4 (1997)
6. Al Hemyari K., Doughty G. F., Wilkinson C. D. W., Kean A. H., Stanley C. R.: “Optical loss measurements on GaAs/GaAlAs single-mode waveguide Y-junctions and waveguide bends”, pp. 272-6, Journal of Lightwave Technology, Vol. 11, Iss. 2 (1993)
7. Patent NO 20045305: “A new process for Te-doped materials and structures”
8. Patent GB 1,097,551: “Method for making Graded Composition Mixed Compound Semiconductor Materials”
9. Patent JP 100 12918 A: “Epitaxial wafer and light emitting diode”
10. U.S. Pat. No. 6,236,772 B: “Linarized Y-fed directional coupler modulators”

1. A method for analysing gas, preferably methane, ethane, propane, butane, pentane, hexane, heptane, ethylene, dichloromethane, isooctane, benzene, xylenes, hydrazine, formaldehyde, N₂O, NO₂, CO₂, CO, HF, O₃, HI, NH₃, SO, HBr, H₂S, HCN, wherein the method includes the following steps:
a) tuning a laser by means of electronic control,
b) transmission of a light signal through the gas in a sense area,
c) measuring the absorbance in a sense area, which sense area is surrounded by a chamber which is perforated in such a way that it allows a surrounding atmosphere, gas and/or smoke to enter the chamber, or a chamber which is supplied with gas, surrounding atmosphere and/or smoke through a gas/air tube,
d) collecting and storing measurements in an internal memory,
e) analysing the measurements by means of a microcontroller,
f) calculating gas concentrations by means an algorithm provided in the microcontroller,
g) repeating the steps a)-f)

2. Method according to claim 1, wherein the method further includes splitting of a light signal from the laser.

3. Method according to claim 1 wherein the method further includes measuring light with an optical detector through a reference cell.

4. Method according to claim 1 wherein the method further includes calibration of the measurement by means of the reference measurement of light through a reference cell.

5. Method according to claim 1, wherein a reference detector is used for measuring light signal through the reference cell.

6. Method according to claim 3, wherein measurements from the reference cell are used to determine the actual wavelength of the laser.

7. Method according to claim 1, wherein the laser changes wavelengths/is tuned with regard to duty cycles and current.

8. Method according to claim 1, wherein a reference is used to establish whether it is a single frequency emission from the laser.

9. Method according to claim 1, wherein the measured transmission is used to calculate the wavelength of the light.

10. Method according to claims 1, wherein the laser is adjusted in wavelength to scan a gas spectrum so that the absorption data from more than one wavelength are collected.

11. Method according to claim 6, wherein a known material, fluid and/or gas is arranged in the reference cell, between the laser and the reference detector to be used as a reference for the absorption spectrum.

12. Method according to claim 1, wherein an internal microcontroller is provided with software which includes an algorithm for calculating wavelengths based on measured absorption.

13. Method according to claim 12, wherein the software is provided with parameters for the mode distance of the light of the laser.

14. Method according to claim 1, wherein the software is arranged to simulate the transmission curve for the different wavelength positions and compare it with the measured spectrum to acquire the absolute values for the single wavelength points.

15. Method according to claim 1, wherein the absorptions from each gas are collected from a library and related to the measured transmission.

16. Method according to claim 15, wherein the composition of gas is computed from the measured absorptions and reference data in the library.

17. Method according to claim 1, wherein the composition of gas is computed from the measured absorptions by comparing the values from the gas which is to be measured and one or one or more reference gas cells.

18. Method according to claim 16, wherein the computed gas composition is used to compute the heat value for the gas in calories.

19. Method according to claim 1, comprising measuring non-flammable gases in a gas flow of mainly hydrocarbons.

20. Method according to claim 1, wherein results and measurements are transferred to an external communication means for further processing.

21. Method according to claim 20, comprising using the transferred information to provide an alarm of gas leakage of one or more gases.

22. Device for gas analysis for carrying out the method of claim 1, comprising a laser (7) of a material with the composition AlₐGa_{b}In_{c}P_{d}AsₑSb_{f}, preferably a junction laser.

23. Device according to claim 22, comprising an intermediate layer of insulating material with contact openings.

24. Device according to claim 22, wherein the laser (7) is made by wet etching.

25. Device according to claim 22, wherein the laser (7) has a waveguide point with a U-shaped detail.

26. Device according to claim 22, wherein a ridge optical waveguide is connected with at least two ridge optical waveguides in a waveguide junction.

27. Device according to claim 26, wherein the waveguide junction consists of at least one incoming waveguide which is extended to at least two outgoing waveguides, so that the optical wave is guided from an incoming waveguide and divided into outgoing waveguides and/or reversed.

28. Device according to claim 27, wherein the etched ridge waveguide junction in the material consists of at least one incoming waveguide which is extended into at least two outgoing waveguides through a junction with 1-10 μm wide U-like detail between the two waveguides, so that the optical wave is guided from the incoming waveguide and divided into outgoing waveguides, and/or reversed.

29. Device according to claim 28, wherein there are at least two elements in the waveguide design around incoming waveguide, with continuous curving from an initial angle of the outgoing waveguide to a parallel, so that the optical field is expanded into the junction before it enters the outgoing waveguides, so that more light is collected.

30. Device according to claim 28, wherein a plastic layer is used between a dielectric insulating layer and a top contact layer, which is connected to the laser (7), so that the plastic layer serves as a soft zone reducing tension at heating and soldering of the laser.

31. Device according to claim 29, wherein the top contact of the laser (7) is soldered down against a holder to provide the best possible thermal conductivity from the active layer of the laser (7).

32. Device according to claim 22, wherein two semi-transparent mirrors (17) are included in the sense area to let the light being reflected back and forth between these, and in this way increase the path length for the light in the gas (especially important at low gas concentrations or low absorption coefficient).

33. Device according to claim 31, wherein the mirrors (17) are provided with a small angle to avoid creating standing waves, which results in that the beam will be displaced along the sense area for each reflection, so that (11) in FIG. 1 must be moved correspondingly.

34. Device according to claim 32, comprising using mirrors (17) with high reflection in the arrangement of claim 32, but having an optical aperture to let the light in at one place and out at another.

35. Device according to claim 22, comprising using curved mirrors (17) to reflect the laser back and forth between these, and having an optical aperture to let the light in at one place and out another.

36. Device according to claim 22, comprising using 3-4 curved mirrors (17) to reflect the laser back and forth within a larger volume in a sense area, as shown in FIG. 20.

37. Device according to claim 22, wherein the accuracy of the gas measurement can be increased by using a filter to remove the lasers at the output of the sense area, and thus measure the gas by Photoluminescence Excitation Spectroscopy or Resonance Raman Spectroscopy, which increases the accuracy of the measuring with a junction laser.

38. Device according to claim 22, wherein a known material, fluid and/or gas is arranged in the reference cell, between the laser (7) and the reference detector (10) to be used as a reference for the absorption spectrum.

39. Device according to claim 22, wherein the internal microcontroller is provided with software including an algorithm for computing wavelengths based on measured absorption.

40. Device according to claim 22, wherein the internal microcontroller is provided with a library for gas references.

41. Device according to claim 22, wherein the device is arranged to compute the composition of gas from the measured absorptions and reference data in the library.

42. Device according to claim 22, wherein the device is arranged to calculate the composition of gas from the measured absorptions by comparing the values from the gas which is to be measured and one or more reference gas cells.

43. Device according to claim 41, wherein the device is arranged to compute the heat value of the gas in calories by utilizing the calculated gas composition.

44. Device according to claim 22, wherein the device is arranged to measure nonflammable gases in a gas flow of mainly hydrocarbons.

45. Device according to claim 22, wherein the laser (7) preferably is a tunable laser which can sweep a spectrum.

46. Device according to clam 22, wherein results and measurements are transferred to an external communication means for further processing.

47. Device according to claim 46, wherein the transferred information is used to provide an alarm of a gas leakage of one or more gases.
